(19) United States
(12) Patent Application Publication
(10) Pub. No.: US 2025/0046900 A1
(43) Pub. Date: Feb. 6, 2025

(54) METHOD FOR MANUFACTURING BATTERY MATERIAL

(71) Applicants: Prime Planet Energy & Solutions, Inc., Tokyo (JP); THE UNIVERSITY OF TOKYO, Tokyo (JP)

(72) Inventors: Shinya SUZUKI, Kobe-shi (JP); Takanari OUCHI, Tokyo (JP)

(21) Appl. No.: 18/788,131

(22) Filed: Jul. 30, 2024

(30) Foreign Application Priority Data
Aug. 3, 2023 (JP) 2023-126806

(51) Int. Cl. H01M 10/54; C22B 3/00; C22B 3/30; C22B 3/32; C22B 3/38; C22B 3/44; C22B 7/00; C22B 23/02; C22B 26/12; C22B 47/00

(52) U.S. Cl. CPC H01M 10/54; C22B 3/30; C22B 3/324; C22B 3/382; C22B 3/3846; C22B 3/44; C22B 7/002; C22B 7/007; C22B 23/02; C22B 23/0415; C22B 23/0453; C22B 26/12; C22B 47/00

(57) ABSTRACT

The manufacture method disclosed herein includes: a preparation step of preparing a recovery object containing lithium and a first metal element; a chlorination heating step of heating the recovery object together with a metal chloride to produce LiCl; and a water dissolution step of immersing the recovery object after the chlorination heating step in water to dissolve LiCl in water to obtain a Li solution. In the manufacture method disclosed herein, a heating temperature in the chlorination heating step is 1000° C. or lower, and the metal chloride contains a second metal element that is more easily chlorinated than the first metal element in the recovered object and more hardly chlorinated than lithium in the chlorination heating step. Thereby, Li can be easily recovered from the recovery object at a low temperature of 1000° C. or lower.

### CROSS REFERENCE TO RELATED APPLICATION

This application claims priority based on Japanese Patent Application No. 2023-126806 filed Aug. 3, 2023, the entirety of which is herein incorporated by reference.

### BACKGROUND OF THE DISCLOSURE

### 1. Field

The technology disclosed herein relates to a method for manufacturing a battery material.

### 2. Background

Lithium ion secondary batteries are widely used in various fields. Various materials including valuable metals such as Ni and Co are used for these lithium ion secondary batteries. For example, as positive electrode active materials, lithium transition metal composite oxides are used, such as lithium-nickel composite oxides, lithium-cobalt composite oxides, lithium-nickel-cobalt composite oxides, and lithium-nickel-cobalt-manganese composite oxides. Aluminum and the like are used for a positive electrode core. On the other hand, carbon materials and the like are used for a negative electrode active material. Copper and the like are used for a negative electrode core. Furthermore, aluminum and the like are also used for battery cases for accommodating these electrodes.

In recent years, development of recovery technologies has been promoted to recover valuable metals from used batteries, process end materials, and the like to reuse them as battery materials, in consideration of environmental influences. An example of the recovery technologies is disclosed in Japanese Patent No. 2022-507413. In the recovery technology described in this literature, a lithium-containing material such as a lithium battery is molten in a metal melting bath furnace. At this time, in the technology described in the above literature, an alkali metal chloride and an alkaline earth metal chloride are added to the melting bath furnace. This process makes it possible to produce a fumed (micronized after evaporation) LiCl. Thus, it is considered that lithium can be recovered from a lithium-containing material.

### SUMMARY

However, in the recovery technology described in the above literature, the fumed LiCl is generated by melting and evaporating a recovery object (lithium battery etc.) and a metal chloride (metal chlorides). Thus, it is necessary to set the temperature in the heating treatment to a high temperature of 1500° C. or higher. That means, it is difficult to consider that the technology described in Japanese Patent No. 2022-507413 sufficiently takes environmental influences into consideration because a large amount of energy is used for recovering Li.

To resolve the above problems, a method for manufacturing a battery material having a configuration described below (hereinafter, also simply referred to as “manufacture method”) is provided.

The method for manufacturing the battery material disclosed herein includes: a preparation step of preparing a recovery object containing lithium and a first metal element; a chlorination heating step of heating the recovery object together with a metal chloride to produce LiCl; and a water dissolution step of immersing the recovery object after the chlorination heating step in water to obtain Li solution in which the LiCl is dissolved in the water. In addition, a heating temperature in the chloride heating step is 1000° C. or lower, and the metal chloride contains a second metal element. In the manufacture method disclosed herein, in the chlorination heating step, the second metal element is easily chlorinated than the first metal element and, the second metal element is hardly chlorinated than lithium.

In the manufacture method having the above configuration, the chlorination heating step of heating the recovery object together with the metal chloride is conducted. The metal chloride used in the technology disclosed herein contains a second metal element that is more easily chlorinated than the first metal element (metal element other than Li) in the recovery object and more hardly chlorinated than Li. When the metal chloride containing such a second metal element is heated, Li can be selectively chlorinated without chlorinating other metal elements (first metal element) in the recovery object. Thereby, lithium chloride (LiCl) can be efficiently produced even by heating at a low temperature of 1000° C. or lower. Since this LiCl is easily dissolved in water, it can be easily separated from the recovery object by conducting the water dissolution step. That means, the manufacture method disclosed herein makes it possible to facilitate recovery of Li with low energy.

### BRIEF DESCRIPTION OF THE DRAWINGS

FIG. 1 is a schematic longitudinal sectional view of an internal structure of a lithium ion secondary battery;

FIG. 2 is a schematic perspective view of an electrode body of the lithium ion secondary battery illustrated in FIG. 1;

FIG. 3 is a flowchart illustrating a method for manufacturing a battery material according to an embodiment;

FIG. 4 is a flowchart illustrating a roasting step in a manufacture method according to an embodiment in detail;

FIG. 5 is a flowchart illustrating a solvent extraction step in a manufacture method according to an embodiment in detail; and

FIG. 6 is a diagram presenting data of an example of a thermodynamic equilibrium in a chlorination heating step.

### DETAILED DESCRIPTION OF THE PREFERRED EMBODIMENTS

Hereinafter, an embodiment of a technology disclosed herein will be explained with reference to the figures. Matters other than those specifically mentioned in this specification, which are necessary for implementing the technology disclosed herein may be understood as design matters for those skilled in the art, based on the prior art in the field. The technology disclosed herein can be implemented based on the contents disclosed in this specification and the general technical knowledge in the field.

### 1. Recovery Object

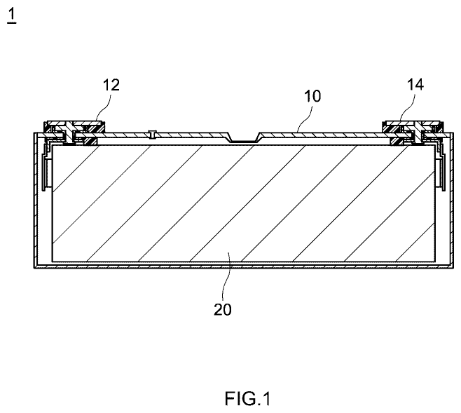

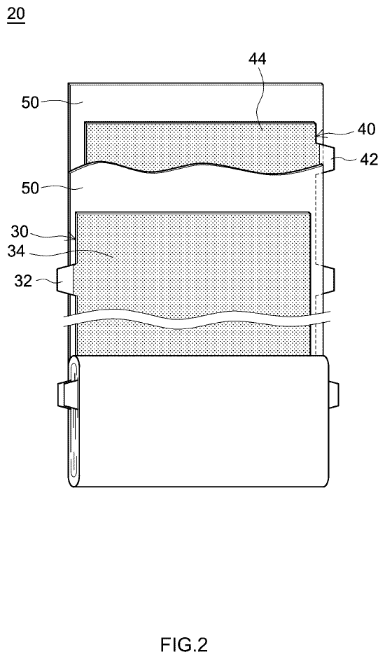

In the method for manufacturing the battery material according to this embodiment, a battery material (typically, a material for a positive electrode active material of lithium ion secondary batteries, a precursor of a positive electrode active material, and a positive electrode active material) is manufactured by recovering valuable metals such as lithium (Li) from a given recovery object. Herein, an example of the recovery object is a used lithium ion secondary battery. This lithium ion secondary battery will be specifically explained below. FIG. 1 is a schematic longitudinal sectional view of an internal structure of a lithium ion secondary battery. FIG. 2 is a schematic perspective view of an electrode body of the lithium ion secondary battery illustrated in FIG. 1.

As illustrated in FIG. 1, a lithium ion secondary battery 1 includes a case 10, an electrode body 20, and an electrolyte (illustration omitted).

### (1) Case

The case 10 is a box-like container. The case 10 accommodates the electrode body 20 and the electrolyte. For the case 10, e.g. a metal material having a certain strength (aluminum (Al) etc.) is used. Also, a positive electrode terminal 12 and a negative electrode terminal 14 are attached to the case 10. The positive electrode terminal 12 and the negative electrode terminal 14 are connected to the electrode body 20 inside the case 10. Specifically, the positive electrode terminal 12 is connected to a positive electrode plate 30 (see FIG. 2) of the electrode body 20. For this positive electrode terminal 12, aluminum (Al) or the like is used. On the other hand, the negative electrode terminal 14 is connected to the negative electrode plate 40 of the electrode body 20. For this negative electrode terminal 14, copper (Cu) or the like is used.

### (2) Electrode Body

The electrode body 20 is a power generating element of the lithium ion secondary battery 1. As illustrated in FIG. 2, the electrode body 20 includes the positive electrode plate 30, the negative electrode plate 40, and a separator 50. The electrode body 20 illustrated in FIG. 2 is a wound electrode body. This wound electrode body is fabricated by laminating the positive electrode plate 30, the negative electrode plate 40, and the separator 50 to form an elongated belt-like laminate and then winding the laminate. However, the structure of the electrode body 20 is not particularly limited, and the electrode body 20 may have another conventionally known structure (laminated electrode body etc.).

The positive electrode plate 30 includes a positive electrode core 32 that is a conductive metal foil, and a positive electrode active material layer 34 provided on a surface of the positive electrode core 32. For the positive electrode core 32, aluminum (Al) and the like is used. The positive electrode active material layer 34 is a composite material layer including a positive electrode active material, a conductive material, a binder, and the like. The positive electrode active material is a metal material containing at least lithium (Li). Examples of this positive electrode active material include lithium transition metal composite oxides such as a lithium-nickel composite oxide, a lithium-cobalt composite oxide, a lithium-manganese composite oxide, a lithium-nickel-manganese composite oxide, a lithium-manganese-cobalt composite oxide, a lithium-nickel-cobalt composite oxide, and a lithium-nickel-manganese-cobalt composite oxide. Other examples of the positive electrode active material include lithium transition metal phosphate compounds such as lithium iron phosphate, lithium manganese phosphate, and lithium ferromanganese phosphate. The manufacture method according to this embodiment makes it possible to improve a recovery efficiency of Li from the recovery object including these positive electrode active materials. In the manufacture method according to this embodiment, other valuable metals such as Ni, Co, and Mn can also be efficiently recovered from the recovery object. For this reason, a lithium transition metal composite oxide containing Ni, Co, and Mn is particularly preferable as the positive electrode active material in the recovery object. Examples of the conductive material include carbon materials such as acetylene black and graphite. Examples of the binder include resin materials such as polyvinylidene fluoride (PVdF).

On the other hand, the negative electrode plate 40 has a negative electrode core 42 that is a conductive metal foil, and a negative electrode active material layer 44 provided on a surface of the negative electrode core 42. For the negative electrode core 42, copper (Cu) and the like is used. The negative electrode active material layer 44 is a composite material layer containing a negative electrode active material, a binder, a thickener, and the like. Examples of the negative electrode active material include carbon materials such as black lead, hard carbon, and soft carbon. Other examples of the negative electrode active material include lithium titanate (LTO), silicon carbide (SiC), a composite containing carbon and silicon, and silicon oxide (SiO_{X}). Examples of the binder include resin materials such as styrene-butadiene rubber (SBR). Examples of the thickener include resin materials such as carboxymethylcellulose (CMC).

The separator 50 is an insulating sheet interposed between the positive electrode plate 30 and the negative electrode plate 40. For this separator 50, e.g. a resin material such as polyethylene (PE), polypropylene (PP), polyester, cellulose, and polyamide is used. A heat-resistant layer including an inorganic filler may be formed on the surface of the separator 50. Examples of the inorganic filler include inorganic oxides such as aluminum oxide, magnesium oxide, silicon oxide, and titanium oxide; nitrides such as aluminum nitride and silicon nitride; metal hydroxides such as calcium hydroxide, magnesium hydroxide, and aluminum hydroxide; as well as clay minerals such as mica, talc, boehmite, zeolite, apatite, and kaolin.

### (3) Electrolyte

The electrolyte is interposed between the positive electrode plate 30 and the negative electrode plate 40. Thereby, charge carriers (Li ions) can be transferred between the positive electrode plate 30 and the negative electrode plate 40. Examples of the electrolyte include a nonaqueous electrolytic solution and a gel electrolyte. As the electrolyte, an electrolyte usable in a lithium ion secondary battery can be used without any particular limitation, and the technology disclosed herein is not limited.

As described above, the lithium ion secondary battery 1 has been explained as an example of the recovery object in the manufacture method according to this embodiment. As described above, this recovery object (lithium ion secondary battery 1) contains various metal elements other than lithium (Li). In this specification, the metal elements other than Li in the recovery object are referred to as a “first metal element”. For example, when the lithium ion secondary battery 1 is to be recovered, the first metal element include Ni, Co, Mn, Al, Cu, Fe, and the like. By the technology disclosed herein, Li can be suitably recovered from the recovery object containing various metal elements as described above.

Note that the recovery object in the manufacture method disclosed herein is not limited to the lithium ion secondary battery 1 having the above-described configuration. For example, when fabricating an electrode body at a manufacture site of lithium ion secondary batteries, a part of a positive electrode plate is cut out in some cases. This cut part (process end material) of the positive electrode plate also contains Li and therefore may be used as a recovery object in the manufacture method disclosed herein. Furthermore, at the manufacture site of lithium ion secondary batteries, some defects may occur on fabricated electrode bodies, and therefore the electrode bodies cannot be used for products in some cases. Such an electrode body also contains Li and therefore may be used as a recovery object. That means, the recovery object in the manufacture method disclosed herein is not limited to a particular structure as long as the recovery object contains at least Li.

### 2. Method for Manufacturing Battery Material

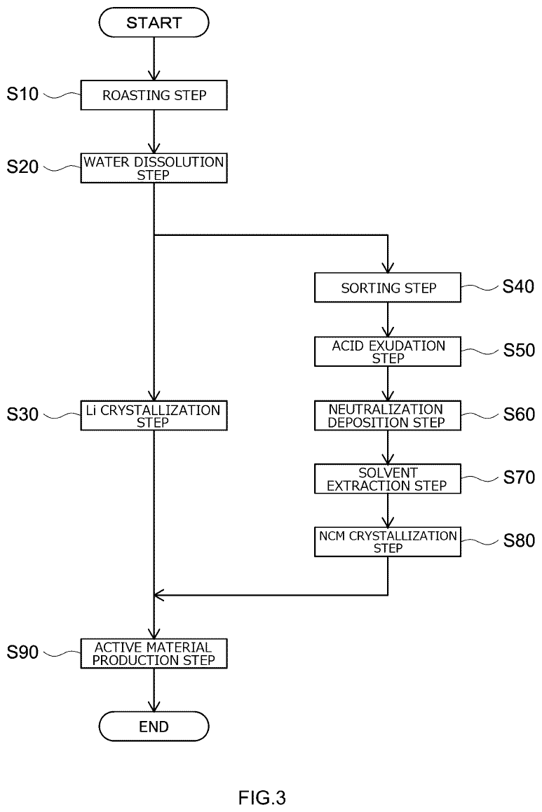

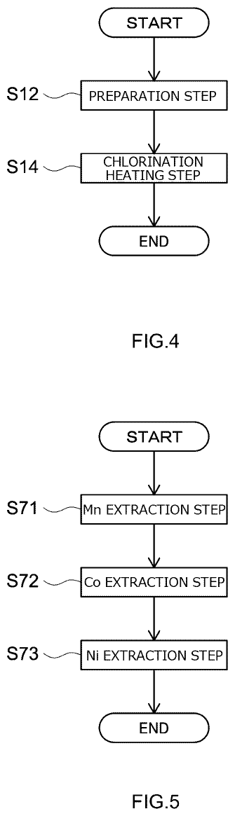

A method for manufacturing the battery material according to this embodiment will be explained below. FIG. 3 is a flowchart illustrating the manufacture method according to this embodiment. FIG. 4 is a flowchart illustrating a roasting step in FIG. 3 in detail. FIG. 5 is a flowchart illustrating a solvent extraction step in FIG. 3 in detail.

As illustrated in FIG. 3, the method for manufacturing the battery material according to this embodiment includes a roasting step S10, a water dissolution step S20, a Li crystallization step S30, a sorting step S40, an acid exudation step S50, a neutralization deposition step S60, a solvent extraction step S70, a nickel-cobalt-manganese (NCM) crystallization step S80, and an active material production step S90. Each step will be explained below.

### (1) Roasting Step S10

In this step, a recovery object is heated at a predetermined temperature. This makes it possible to remove liquid components (electrolytic solution etc.) in the recovery object and to carbonize resin components (binder, separator, etc.). When the charged lithium ion secondary battery 1 is used as a recovery object, the battery function can be deactivated by conducting the roasting step S10. Thereby, the subsequent steps can be conducted safely.

As illustrated in FIG. 4, the roasting step S10 in this embodiment includes a preparation step S12, and a chlorination heating step S14. Thereby, the Li recovery efficiency can be significantly improved. Each step will be specifically explained below.

### (a) Preparation Step S12

In this step, a recovery object containing lithium and the first metal element is prepared. As described above, the “recovery object” in the technology disclosed herein is not limited to completed lithium ion secondary batteries but includes process end materials and defective parts (electrode body etc.). Since the details of the recovery object have been already explained above, repeated explanations are omitted. The manufacture method according to this embodiment makes it possible to recover (manufacture) not only the above-described lithium (Li) but also nickel (Ni), cobalt (Co), manganese (Mn), and the like.

### (b) Chlorination Heating Step S14

In the chlorination heating step S14, the recovery object is heated together with a metal chloride. In this chlorination heating step S14, Li in the recovery object is chlorinated by chlorine element (Cl) separated from the metal chloride. Thereby, lithium chloride (LiCl) is produced in the recovery object. Since this LiCl is easily dissolved in water, it can be easily separated from the recovery object.

The “metal chloride” in the technology disclosed herein contains a second metal element that is more easily chlorinated than the first metal element in the recovered object and more hardly chlorinated than Li in the chlorination heating step S14. When the metal chloride containing this second metal element is heated, Li can be selectively chlorinated without chlorinating the first metal element in the recovery object. Thus, lithium chloride (LiCl) can be efficiently produced.

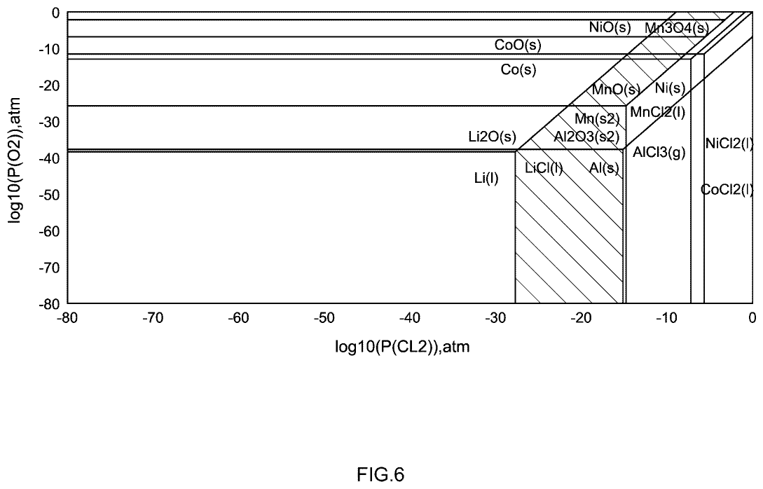

It is preferable that the second metal element in the metal chloride is selected as appropriate from various metal elements, e.g. considering the thermodynamic equilibrium state of each component in the recovery object as illustrated in FIG. 6. Specifically, FIG. 6 presents data of a thermodynamic equilibrium state when a recovery object containing Li, Ni, Co, Mn, Al, and Cu is heated at 927° C. (1200 K). The abscissa in FIG. 6 indicates a chlorine partial pressure (log₁₀P_{C12}·atm). The ordinate indicates an oxygen partial pressure (log₁₀P_{O2}·atm). The thermodynamic equilibrium state presented in FIG. 6 can be calculated and created by using thermodynamic data of each element and compound.

Specifically, the second metal element in the metal chloride is surrounded by a line indicating an equilibrium between the Li oxide and the chloride (Li₂O/LiCl equilibrium), a line indicating an equilibrium between the Li metal and the chloride (Li/LiCl equilibrium), a line indicating an equilibrium between the first metal element and the chloride (M/MCl₂ₓ equilibrium), and a line indicating an equilibrium between the metal oxide and metal chloride of the first metal element (MOₓ/MCl₂ₓ equilibrium). It is preferable to select a metal element P that enables setting of PO₂ and PCl₂ in the hatched line area in FIG. 6. Li can be selectively chlorinated without chlorinating the first metal element in the recovery object by controlling the oxygen partial pressure in the chlorination heating step S14 as necessary. Examples of this second metal element include alkaline earth metals (Ca, Mg, Ba, Sr, Ra, Be, etc.) and alkaline metals (Na, K, Rb, Cs, Fr). LiCl can be more suitably produced by using chlorides of these second metal elements as a chlorine source. However, the second metal element in the technology disclosed herein is not limited to the above-described elements and may be appropriately selected based on the thermodynamic equilibrium state of each component in the recovery object. As an example, as presented in FIG. 6, when the recovery object contains Li, Ni, Co, Mn, Cu, and Al, it is preferable to select an alkaline earth metal (particularly, Ca, Mg) as the second metal element.

Preferably, a Cl content ratio in the metal chloride relative to a Li content in the recovery object (Cl/Li) is preferably 1 or higher. Thereby, Li in the recovery object can be suitably chlorinated. From the viewpoint of improving the LiCl production efficiency, the Cl/Li is preferably 2 or higher, more preferably 4 or higher, even more preferably 6 or higher, particularly preferably 8 or higher. On the other hand, the upper limit of the Cl/Li may be, but is not particularly limited to, 20 or lower, 18 or lower, 16 or lower, 14 or lower, or 12 or lower.

The heating temperature in this step is set to 1000° C. or lower. According to the technology disclosed herein, LiCl can be efficiently produced even when the heating temperature is low, and therefore Li can be recovered with a lower energy than before. The upper limit of the heating temperature is preferably 975° C. or lower, more preferably 950° C. or lower. As the heating temperature is decreased, the energy required for recovering Li can be further decreased. On the other hand, the lower limit of the heating temperature is preferably 800° C. or higher, more preferably 850° C. or higher, even more preferably 900° C. or higher, particularly preferably 925° C. or higher. There is a tendency that, as the heating temperature is improved, the LiCl production efficiency is improved.

The pressure in the chlorination heating step S14 is not particularly limited and may be set as appropriate. Although described later in detail, the present inventors have confirmed that LiCl is suitably produced even when conducting the chlorination heating step S14 at atmospheric pressure (about 1.0×10⁵ Pa). On the other hand, there is a tendency that, as the pressure in the chlorination heating step S14 is decreased, the LiCl production efficiency is improved. Specifically, the pressure in the chlorination heating step S14 is preferably 1.0×10³ Pa or lower, more preferably 7.5×10² Pa or lower, even more preferably 5.0×10² Pa or lower, particularly preferably 2.5×10² Pa or lower. On the other hand, the lower limit of the pressure in the chlorination heating step S14 may be, but is not particularly limited to, 1.0×10⁰ Pa or higher, 5.0×10⁰ Pa or higher, 1.0×10¹ Pa or higher, or 5.0×10¹ Pa or higher.

In this step, the recovery object may be heated under an inert atmosphere to control the oxygen partial pressure. Specific examples of the heating gas used in this step include inert gases such as argon gas. The term “inert atmosphere” in this specification refers to a heating atmosphere mainly containing the above-described inert gas. In other words, the “inert atmosphere” in this specification is not limited to a completely inert atmosphere with 100% inert gas content (0% oxygen element content) but may contain a trace amount of oxygen element. Specifically, the heating atmosphere in this step only needs to contain 5% or less (preferably 3% or less, more preferably 1% or less, even more preferably 0.5% or less, particularly preferably 0.1% or less) of oxygen element.

In this step, it is preferable that the recovery object and the metal chloride are heated in different containers. In this case, the container of the recovery object and the container of the metal chloride can be ventilatably communicated with each other to chlorinate Li in the recovery object. According to such a configuration, the second metal element in the metal chloride can be suppressed from contaminating the recovery object to a necessary minimum limit, and therefore decrease in the valuable metal recovery efficiency due to the impurity contamination can be prevented.

### (2) Water Dissolution Step S20

Subsequently, in the water dissolution step S20, the recovery object after the chlorination heating step S14 is immersed in water. As described above, the recovery object after the chlorination heating step S14 contains LiCl. This LiCl is easily dissolved in water such as pure water and ion-exchanged water. As a result, in this step, LiCl can be dissolved in water to obtain a Li solution. Thus, in the manufacture method according to this embodiment, Li can be directly separated from the recovery object immediately after the chlorination heating step S14, resulting in a Li solution containing Li at high purity.

The immersion time in this step is preferably 10 minutes or longer, 15 minutes or longer, 20 minutes or longer, particularly preferably 25 minutes or longer. Thereby, LiCl in the recovery object can be sufficiently dissolved in water. If the immersion time is longer than 30 minutes, almost whole LiCl in the recovery object can be dissolved in water. For this reason, considering the producibility, the upper limit of the immersion time is preferably 120 minutes or shorter, 90 minutes or shorter, 60 minutes or shorter, particularly preferably 45 minutes or shorter. The temperature of water in this step is not particularly limited and may be set as appropriate within a range of 10° C. to 60° C.

### (3) Li Crystallization Step S30

In this step, a Li compound crystal is precipitated from the Li solution. In this step, any conventionally known crystallization treatment can be adopted without any particular limitation. For example, in this step, sodium carbonate should be added to the Li solution. Thereby, a lithium carbonate (Li₂CO₃) crystal can be precipitated. Note that the Li compound produced in this step is not limited to lithium carbonate. For example, lithium hydroxide (LiOH) may be produced as the Li compound as necessary. In the production of lithium hydroxide, lithium carbonate precipitated from the metal solution is first dissolved (or suspended) in a predetermined solvent. Then, calcium hydroxide is added to this solution. Subsequently, the solvent is evaporated off as necessary. Thus, a lithium hydroxide crystal can be precipitated.

As described above, in the manufacture method according to this embodiment, Li can be directly recovered from the metal solution (Li solution) produced after the roasting step S10. That means, in the manufacture method according to this embodiment, the number of steps from the completion of the roasting step S10 to the recovery of Li can be significantly decreased. Thus, a high Li recovery ratio can be achieved.

### (4) Sorting Step S40

On the other hand, the first metal element (Ni, Co, Mn, Al, Cu, Fe, etc.) that has not chlorinated in the chlorination heating step S14 remains in the solid content (recovery object) after the water dissolution step S20. In contrast, in the manufacture method according to this embodiment, valuable metals (Ni, Co, Mn) are recovered from the recovery object after the water dissolution step S20. Specifically, in this embodiment, the sorting step S40 is conducted after the roasting step S10. In this step, each component in the recovery object after the roasting is sorted using a sieve. For example, when the process end material of the positive electrode plate 30 is to be recovered, the positive electrode core 32 should be sorted from the process end material using a sieve and removed from the recovery object. When the electrode body 20 is to be recovered, in addition to the positive electrode core 32, the negative electrode plate 40 should also be removed from the recovery object. Furthermore, when the lithium ion secondary battery 1 is to be recovered, in addition to the above-described positive electrode core 32 and negative electrode plate 40, the case 10 should also be removed from the recovery object. Thus, the content of impurities (Al, Cu, etc.) in the recovery object is decreased, contributing to improvement of the recovery efficiency of the valuable metals (Co, Ni, Mn). As in this embodiment, it is preferable that the sorting step is conducted after the water dissolution step. Thus, LiCl that has adhered to the objects to be removed (positive electrode core, negative electrode plate, case, etc.) can be recovered in advance.

In this step, the recovery object may be crushed as necessary. Thereby, the sorting efficiency of each component can be improved. For example, when the lithium ion secondary battery 1 is to be recovered, the case 10 and the electrode body 20 should be crushed. This facilitates removal of the case 10, the positive electrode core 32, and the negative electrode plate 40 from the recovery object.

The sorting step S40 is not intended to completely remove impurities such as Al and Cu from the recovery object. As described later in detail, even if impurities remain in the recovery object, impurities can be sufficiently removed in subsequent steps (neutralization deposition step S60, solvent extraction step S70, etc.). That means, this step may be arbitrarily omitted as necessary. For example, when using a recovery object containing a small amount of impurities (process end material of positive electrode plate 30, etc.), valuable metals can be efficiently recovered even if this step is omitted.

### (5) Acid Exudation Step S50

In the acid exudation step S50, the solid content after the water dissolution step S20 is immersed in an acid liquid. Thereby, the first metal element in the recovery object can be dissolved in the acid liquid to obtain a metal solution. For the acid exudation procedure, any conventionally known procedure can be adopted without any particular limitation. As an example, the acid liquid used in this step is preferably at pH −1.5 to 1.5 (more preferably −0.5 to 0.5). This pH allows the metal components in the recovery object to be suitably dissolved. Specific examples of the acid liquid include inorganic acids such as sulfuric acid, nitric acid, hydrochloric acid, and phosphoric acid, as well as organic acids such as citric acid, ascorbic acid, oxalic acid, and acetic acid. In this step, it is preferable that the metal solution after the acid exudation is subjected to a filtration treatment. Thereby, undissolved components (carbon components etc.) can be efficiently removed. The temperature of the acid liquid is preferably 50° C. or higher (more preferably 55° C. or higher, particularly preferably 60° C. or higher). Thus, the acid exudation step S30 can be shortened. The upper limit temperature of the acid liquid may be 90° C. or lower, 85° C. or lower, or 80° C. or lower without any particular limitation.

### (6) Neutralization Deposition Step S60

In this step, a neutralizer is added to the metal solution obtained in the acid exudation step S50. Thereby, Al hydroxide (Al(OH)₃) is precipitated and deposited. As a result, Al can be almost removed from the metal solution containing Al, Cu, Co, Ni, Mn, and the like. As the neutralizer used in this step, an alkaline solution at pH 11 to 15 (preferably pH 12 to 14) can be used. Specific examples of the neutralizer include a sodium hydroxide aqueous solution, calcium hydroxide, and ammonia. Also in this step, it is preferable to filter the metal solution after deposition of Al(OH)₃. Thus, Al(OH)₃ can be efficiently removed from the metal solution.

### (7) Solvent Extraction Step S70

In this step, each of Co, Ni, and Mn is extracted from the metal solution using a solvent extraction method. Thereby, a Co solution, an Ni solution, and an Mn solution can be each prepared. Also in this step, impurities (Al etc.) remaining in the metal solution can be separated. Specifically, the solvent extraction step S70 according to this embodiment includes an Mn extraction step S71, a Co extraction step S72, and an Ni extraction step S73, as illustrated in FIG. 5. Each step will be specifically explained below.

### (a) Mn Extraction Step S71

In this step, an organic solvent (first extractant) with a high extractability for Mn and a low extractability for Li, Al, Cu, Co, and Ni is added to the metal solution. As the first extractant, a phosphoric acid ester-based extracting agent, an oxime-based extracting agent, or the like can be used. Specific Examples of the phosphoric acid ester-based extracting agent include di-2-ethylhexyl phosphoric acid (D2EHPA). Specific examples of the oxime-based extracting agent include 2-hydroxy-5-nonylacetophenoneoxime (LIX84), 5-dodecylsalicylaldoxime (LIX860), and 5-nonylsalicylaldoxime (ACORGA M5640). The first extractant may be prepared by mixing these extracting agents and diluting the mixture. In this step, the metal solution and the first extractant are stirred to suspend the metal in the first extractant. Thereby, Mn in the metal solution dissolves in the first extractant. Then, the solution is left to stand until the two liquids are separated from each other, to obtain an Mn solution with Mn dissolved in the first extractant, and the first extractant from which Mn has been removed.

In this step, the Mn solution (first extractant containing Mn) after extraction may be subjected to a stripping treatment. In this stripping treatment, the Mn solution (organic phase) and an acidic aqueous solution are first stirred and mixed using a mixer or the like. Then, the mixture was allowed to stand until the two liquids are separated from each other to obtain an aqueous Mn solution with Mn dissolved in the acidic aqueous solution. Examples of the acidic aqueous solution used for the stripping treatment include sulfuric acid and hydrochloric acid (particularly sulfuric acid).

### (b) Co Extraction Step S72

In this step, an organic solvent (second extractant) with a high extractability for Co and a low extractability for Li, Al, Cu, and Ni is added to the metal solution. Thereby, Co is separated from the metal solution, and a Co solution with Co dissolved in the second extractant can be obtained. Specific examples of the second extractant include phosphonate esters such as 2-ethylhexyl (2-ethylhexyl) phosphonate (PC-88A). Also, the Co solution (metal solution containing Co) after the extraction may be subjected to a stripping treatment to obtain an aqueous Co solution. Since the stripping procedure has been already explained above, repeated explanations are omitted.

### (c) Ni Extraction Step S73

In this step, an organic solvent (third extractant) with a high extractability for Ni and a low extractability for Li, Al, and Cu is added to the metal solution. Thereby, Ni is separated from the metal solution, and a Ni solution with Ni dissolved in the third extractant can be obtained. Specific examples of the third extractant include carboxylic acid-based extracting agents such as neodecanoic acid and naphthenic acid. Also, the Ni solution (third extractant containing Ni) after the extraction may be subjected to a stripping treatment to obtain an aqueous Ni solution. Since the stripping procedure has been already explained above, repeated explanations are omitted.

### (8) NCM Crystallization Step S80

In this step, a metal compound crystal is precipitated from each of the Co solution, Ni solution, and Mn solution. In this step, a conventionally known crystallization treatment can be adopted without any particular limitation. For example, if the stripping treatment has been conducted in each of the steps from the Mn extraction step S71 to the Ni extraction step S73, an aqueous mixture is prepared by mixing the Co solution, Ni solution, and Mn solution. Then, the pH of this mixture is adjusted to be alkaline. Thereby, a metal compound crystal can be precipitated. In the preparation of the mixture, each mixing ratio of the Co solution, Ni solution, and Mn solution should be changed as necessary. Then, in the pH adjustment, the mixture is dripped into a reaction tank together with an alkaline solution (ammonia water, sodium hydroxide aqueous solution). Thus, a spherical NiCoMn hydroxide (NCM precursor) can be crystallized.

### (9) Active Material Production Step S90

In this step, a battery material (positive electrode active material) is produced using the metal compound obtained in the NCM crystallization step S80 and the Li compound obtained in the Li crystallization step S30. Specifically, NiCoMn hydroxide (NCM precursor) and the Li compound (Li₂CO₃ etc.) are mixed and baked to manufacture a positive electrode active material (lithium transition metal composite oxide) for lithium ion secondary batteries.

The method for manufacturing the battery material according to this embodiment has been explained above. As described above, in the roasting step S10 in the manufacture method according to this embodiment, the chlorination heating step S14 is conducted, in which the recovery object is heated together with a metal chloride. As the metal chloride used in the chlorination heating step S14, a chloride of the second metal element that is more easily chlorinated than the first metal element in the recovered object and more hardly chlorinated than Li is used. Thereby, Li can be selectively chlorinated without chlorinating the first metal element in the recovery object. As a result, lithium chloride (LiCl) can be efficiently generated even by heating at a low temperature of 1000° C. or lower. In the production method according to this embodiment, the water dissolution step S20 is conducted, in which LiCl in the recovery object is dissolved in water. Thus, Li can be recovered from the recovery object with low energy.

### 3. Other Embodiments

One embodiment of the technology disclosed herein has been explained above. The technology disclosed herein is not limited to the embodiment described above but includes other embodiments with variously-changed configurations. Other examples of embodiments of the technology disclosed herein will be explained below.

In the manufacture method according to the embodiment described above, the sorting step S40, and the Li crystallization step to the active material production step S90 are conducted in addition to the roasting step S10 and the water dissolution step S20. However, the explanation on the embodiment described above is not intended to limit the steps other than the roasting step S10 and the water dissolution step S20. That means, in the manufacture method disclosed herein, steps other than the roasting step S10 and the water dissolution step S20 can be arbitrarily added, deleted, and changed as necessary.

### (1) Modification of Solvent Extraction Step

For example, the specific treatment procedure in the solvent extraction step S70 can be modified as appropriate. For example, the solvent extraction step S70 according to the embodiment described above includes the Mn extraction step S71, the Co extraction step S72, and the Ni extraction step S73. Thereby, the Co solution, Ni solution, and Mn solution can be separately extracted. However, in the solvent extraction step S70, a plurality of valuable metals may be simultaneously extracted. For example, an organic solvent with a high extractability for Ni and Co and a low extractability for Li, Al, and Cu should be added to the metal solution after the Mn extraction. Thus, Ni and Co can be simultaneously extracted. When a plurality of valuable metals are simultaneously extracted in this way, the producibility can be improved by shortening the process.

### (2) Addition of Li Separation Step

The Li solution before the Li crystallization step S30 may be subjected to a Li separation step. Specifically, the Li solution contains Li as a main component. However, this Li solution may contain other metal components (Cu, Al, etc.). In the Li separation step, impurities are removed from the Li solution. Thus, a high-purity Li compound can be obtained in the Li crystallization step S30. The means for preparing the Li solution is not particularly limited, and any conventionally known means such as solvent extraction and ion exchange should be adopted as appropriate.

### (3) Addition of Li Concentration Step

The Li solution after the Li separation step may be subjected to a Li concentration step. In this Li concentration step, the Li solution is heated to evaporate the solvent. Thereby, a high concentration Li solution can be obtained, so that the crystallization efficiency in the Li crystallization step S30 can be improved. This Li concentration step may be conducted for a metal solution that has not been subjected to the Li separation step. For example, if impurities are sufficiently removed in the water dissolution step S20, only the Li concentration step may be conducted without the Li separation step. Also in this case, a high concentration Li solution can be obtained.

### (4) Modification of NCM Crystallization Step

In the above embodiment, the mixture of Co solution, Ni solution, and Mn solution has been subjected to the NCM crystallization step S80. Thereby, the NiCoMn hydroxide can be crystallized as a metal compound containing Co, Ni, and Mn. However, in the NCM crystallization step, each metal compound may be separately crystallized from the Co solution, Ni solution, and Mn solution. When stripping is performed with sulfuric acid as described in the above embodiment, a manganese sulfate (MnSO₄) crystal can be precipitated from the Mn solution by removing and cooling the solvent as necessary. Also, a cobalt sulfate (CoSO₄) crystal is precipitated from the Co solution. Furthermore, a nickel sulfate (NiSO₄) crystal is precipitated from the Ni solution. The NCM hydroxide synthesized from these sulfate crystals can be mixed with the Li compound and baked to produce a battery material (positive electrode active material).

### Test Examples

Test examples related to the technology disclosed herein will be explained below. The contents of the test examples described below are not intended to limit the technology disclosed herein.

### 1. Preparation of Sample

In this test, six types of recovery treatments with different roasting step conditions were performed. Six types of test samples (Examples 1 to 6) obtained from each recovery treatment will be explained below.

### (1) Example 1

In Example 1, a mixture of a positive electrode plate and a negative electrode plate was used as the recovery object, and the recovery object was subjected to a roasting step. Specifically, as the positive electrode plate, a positive electrode core (Al foil) with a surface coated with a positive electrode active material layer was used. As the positive electrode active material, a lithium-nickel-cobalt-manganese composite oxide (LiNi_{1/3}Co_{1/3}Mn_{1/3}O₂) was used. On the other hand, as the negative electrode plate, a negative electrode core (Cu foil) with a surface coated with a negative electrode active material layer was used. As the negative electrode active material, black lead was used. These positive and negative electrode plates were cut out into a 1 cm×3 cm sheet, which was prepared as the recovery object.

Subsequently, in this test, a roasting step was conducted, in which the recovery object is heated together with a metal chloride (CaCl₂)). Specifically, in the roasting step of this test, a double-structural glass tube was prepared. Then, the recovery object was put into the inner glass tube, and the metal chloride was put into the outer glass tube. In this test, the amount of the metal chloride was adjusted so that a ratio of the Cl content in the metal chloride relative to the Li content in the recovery object (Cl/Li) was 10. Then, the glass tube was depressurized so that the pressure inside the glass tube was 2.0×10² Pa. After that, the glass tube was charged into an electric furnace and the temperature inside the furnace was raised to 927° C. At this time, a temperature increase rate was set to 10° C./min. The recovery object was roasted for 1 hour while maintaining the furnace temperature at 927° C. Subsequently, the furnace temperature was decreased to 50° C., and then the recovery object was recovered. In this test, the recovery object after this heating was used as a test sample (Example 1).

### (2) Example 2

In Example 2, the roasting step was conducted under the same condition as in Example 1 except that the type of metal chloride was changed to NaCl₂.

### (3) Example 3

In Example 3, the roasting step was conducted under the same condition as in Example 1 except that the metal chloride was changed to MgCl₂.

### (4) Example 4

In Example 4, the roasting step was conducted under the same condition as in Example 1 except that the metal chloride was not used.

### (5) Example 5

In Example 5, the roasting step was conducted under the same condition as in Example 1 except that the heating temperature was decreased to 727° C.

### (6) Example 6

In Example 6, the roasting step was conducted under the same condition as in Example 1 except that heating was performed without depressurizing the glass tube (at atmospheric pressure).

2. Evaluation test

In this test, each test sample of Examples 1 to 6 was immersed in water for 30 minutes to obtain a Li solution, and then the Li solution was filtered to remove the solid content. The filtered Li solution was subjected to an inductively coupled plasma (ICP) to measure a quantity of Li in the Li solution. A recovery ratio of each element was calculated based on the following equation. The measurement results are presented in Table 1. The “metal element amount before roasting” in the equation refers to a metal element amount determined by analyzing the reference sample before roasting by ICP.

Recovery ratio=(metal element amount in Li solution/metal element amount before roasting)×100

TABLE 1

| | | | | Li recovery |
|---|---|---|---|---|
| | Chlorine | Pressure | Temperature | ratio |
| | source | (Pa) | (° C.) | (%) |
| Example 1 | CaCl₂ | 2.0 × 10² | 927 | 96 |
| Example 2 | NaCl | 2.0 × 10² | 927 | 50 |
| Example 3 | MgCl₂ | 2.0 × 10² | 927 | 95 |
| Example 4 | — | 2.0 × 10² | 927 | 54 |
| Example 5 | CaCl₂ | 2.0 × 10² | 727 | 70 |
| Example 6 | CaCl₂ | 1.0 × 10⁵ | 927 | 90 |

As a result of the above test, Li recovery ratios of as high as 70% or higher were confirmed in Examples 1, 3, 5, and 6. This result indicates that Li can be suitably recovered by selecting a proper metal chloride in the roasting step, even when the heat treatment is performed at a low temperature of 927° C. or lower.

As described above, the technologies disclosed herein have been explained in detail, but these technologies are merely examples and are not intended to limit claims. The technologies described in claims include various variations and modifications of the specific examples illustrated above. That means, the technologies disclosed herein encompass configurations described in the following items 1 to 7.

### <Item 1>

A method for manufacturing a battery material, comprising:
a preparation step of preparing a recovery object containing lithium and a first metal element;
a chlorination heating step of heating the recovery object together with a metal chloride to produce LiCl; and
a water dissolution step of immersing the recovery object after the chlorination heating step in water to obtain Li solution in which the LiCl is dissolved in the water, wherein
a heating temperature in the chloride heating step is 1000° C. or lower, and
the metal chloride contains a second metal element,
in the chlorination heating step, the second metal element is easily chlorinated than the first metal element and, the second metal element is hardly chlorinated than lithium.

### <Item 2>

The method according to Item 1, in which the first metal element includes at least one selected from a group consisting of Ni, Co, Mn, Al, Cu, and Fe.

### <Item 3>

The method according to Item 1 or 2, in which the second metal element includes at least one selected from a group consisting of Ca, Mg, Ba, Sr, Ra, and Be.

### <Item 4>

The method according to any one of Items 1 to 3, in which the heating temperature is 800° C. or higher.

### <Item 5>

The method according to any one of Items 1 to 4, in which the chlorination heating step is conducted under a reduced pressure environment at 500 Pa or lower.

### <Item 6>

The method according to any one of Items 1 to 5, further including a Li precipitation step of precipitating a Li compound crystal from the Li solution.

### <Item 7>

The method according to any one of Items 1 to 6, further including an acid exudation step of immersing solids after the water dissolution step in an acid liquid to dissolve the first metal element in the acid liquid to obtain a metal solution.

What is claimed is:

1. A method for manufacturing a battery material, comprising:
a preparation step of preparing a recovery object containing lithium and a first metal element;
a chlorination heating step of heating the recovery object together with a metal chloride to produce LiCl; and
a water dissolution step of immersing the recovery object after the chlorination heating step in water to obtain Li solution in which the LiCl is dissolved in the water, wherein
a heating temperature in the chloride heating step is 1000° C. or lower, and
the metal chloride contains a second metal element,
in the chlorination heating step, the second metal element is easily chlorinated than the first metal element and, the second metal element is hardly chlorinated than lithium.

2. The method according to claim 1, wherein the first metal element includes at least one selected from a group consisting of Ni, Co, Mn, Al, Cu, and Fe.

3. The method according to claim 2, wherein the second metal element includes at least one selected from a group consisting of Ca, Mg, Ba, Sr, Ra, and Be.

4. The method according to claim 1, wherein the heating temperature is 800° C. or higher.

5. The method according to claim 1, wherein the chlorination heating step is conducted under a reduced pressure environment at 5.0×10² Pa or lower.

6. The method according to claim 1, further comprising a Li precipitation step of precipitating a Li compound crystal from the Li solution.

7. The method according to claim 1, further comprising an acid exudation step of immersing solids after the water dissolution step in an acid liquid to dissolve the first metal element in the acid liquid to obtain a metal solution.
